(19) United States
(12) Patent Application Publication
(10) Pub. No.: US 2015/0240727 A1
(43) Pub. Date: Aug. 27, 2015

(54) INLET THROTTLE

(71) Applicant: NORGREN GT DEVELOPMENT CORPORATION, Auburn, WA (US)

(72) Inventors: Adam Coker, whiteland, IN (US); Mark Sealy, Warwickshire (GB)

(73) Assignee: NORGREN GT DEVELOPMENT CORPORATION, Auburn, WA (US)

(21) Appl. No.: 14/432,379

(22) PCT Filed: Oct. 9, 2013
(86) PCT No.: PCT/US2013/063996

§ 371 Date: Mar. 30, 2015

Related U.S. Application Data
(60) Provisional application No. 61/712,363, filed on Oct. 11, 2012.

(51) Int. Cl. F02D 9/10; F02D 11/02

(52) U.S. Cl. CPC F02D 9/109; F02D 9/107; F02D 11/02

(57) ABSTRACT

An inlet throttle (100) in provided. The inlet throttle (100) comprises a housing (110) with an aperture (112) adapted to channel a flow stream through the housing (110), a flapper (120) disposed inside the aperture (112) and rotatably coupled to the housing (110) along an axis of rotation (X), and two actuators (130a,b) with drive shafts (132a,b) coupled to opposite ends of the flapper (120) such that the drive shafts (132a,b) rotate coaxial with the axis of rotation (X).

### TECHNICAL FIELD

The embodiments described below relate to throttles, and more particularly, to an inlet throttle.

### BACKGROUND

Engines typically use inlet throttles to regulate a flow stream to affect the performance of the engine. The inlet throttle reduces a flow rate of the flow stream to reduce the engine output and increases the flow rate to increase the engine output. This regulation of the flow stream is usually done with a flapper in the inlet throttle that rotates about an axis. To rotate the flapper, prior art inlet throttles typically employ a single actuator that is coupled to the flapper. However, the flapper is in the path of the flow stream which causes the flow stream to exert forces onto the flapper. The torque applied by the actuator must be sufficient to rotate the flapper at a desire rotation rate even though the flow stream is applying forces to the flapper. The magnitudes of the forces applied by the flow stream are usually proportional to the displacement size of the engine. For large displacement engines, the forces on the flapper can be considerable.

As a result, large displacement engines typically require inlet throttles with a single large actuator. The large displacement engines also usually require increased complexity of the inlet throttle. For example, the inlet throttles for large displacement engines frequently employ mechanical advantage linkages or gearboxes as well as additional or larger bearings. The increased size and complexity results in a heavier inlet throttle. Compounding these issues is that large displacement engine environments induce considerable vibration, dynamic pressure, and thermal loads in the inlet throttle.

A more complex inlet throttle with a single large actuator is not desirable. One large actuator is not suitable for the cramped spaces of, for example, an engine bay. The available space in the engine bay may be very limited due to the large displacement engine. The large actuator can also result in a disproportionate and inefficient use of the available space. That is, the inlet throttle with the large actuator requires more space on the actuator side. The larger actuator can also have a slower actuation time. More specifically, the larger mass and moment of inertia can cause actuation time of the flapper rotation to be less than desired for the torque the actuator is able to provide. In addition, the inlet throttle with the single actuator lacks redundancy. For example, failure of the single actuator results in a complete failure of the inlet throttle and a non-functional engine. A more complex inlet throttle has a higher probability of failure due to the increased number of potential failure modes. Moreover, bearings, gear boxes, and linkages can be prone to failure in environments that include large thermal loads and vibration.

Accordingly, there is a need for a reliable inlet throttle for large displacement engines that does not have the complexity, size and weight of single actuator inlet throttle.

### SUMMARY

An inlet throttle is provided. According to an embodiment, the inlet throttle an inlet throttle comprises a housing with an aperture adapted to channel a flow stream through the housing. The inlet throttle further comprises a flapper disposed inside the aperture and rotatably coupled to the housing along an axis of rotation X and two actuators with drive shafts coupled to opposite ends of the flapper such that the drive shafts rotate coaxial with the axis of rotation X.

A method of forming an inlet throttle is provided. According to an embodiment, the method comprises forming and adapting a housing with an aperture to channel a flow stream through the housing. The method further comprises forming and disposing a flapper inside the aperture and rotatably coupling the flapper to the housing along an axis of rotation X and forming and coupling two actuators with drive shafts to opposite ends of the flapper such that the drive shafts rotate coaxial with the axis of rotation X.

An inlet throttle control system is provided. According to an embodiment, the inlet throttle control system comprises a throttle valve that includes a flapper that rotates about an axis of rotation X, and two actuators with drive shafts coupled to opposing ends of the flapper such that the drive shafts rotate coaxial with the axis of rotation X. The inlet throttle control system further comprises a controller adapted to provide a signal that rotates the drive shafts in opposite directions.

### ASPECTS

According to an aspect, an inlet throttle (100) comprises a housing (110) with an aperture (112) adapted to channel a flow stream through the housing (110), a flapper (120) disposed inside the aperture (112) and rotatably coupled to the housing (110) along an axis of rotation (X), and two actuators (130a,b) with drive shafts (132a,b) coupled to opposite ends of the flapper (120) such that the drive shafts (132a,b) rotate coaxial with the axis of rotation (X).

Preferably, the two actuators (130a,b) are coupled to the housing (110) proximate the opposite ends of the flapper (120).

Preferably, the two actuators (130a,b) are positioned to rotate the drive shafts (132a,b) in the same direction about the axis of rotation (X).

Preferably, the two actuators (120) are adapted to receive signals that rotate the drive shafts (132a,b) in opposite directions.

Preferably, the two actuators (120) are adapted to rotate the drive shafts (132a,b) with an equal amount of torque.

According to an aspect, a method of forming an inlet throttle (100) comprises forming and adapting a housing (110) with an aperture (112) to channel a flow stream through the housing (110), forming and disposing a flapper (120) inside the aperture (112) and rotatably coupling the flapper (120) to the housing (110) along an axis of rotation (X), and forming and coupling two actuators (130a,b) with drive shafts (132a,b) to opposite ends of the flapper (120) such that the drive shafts (132a,b) rotate coaxial with the axis of rotation (X).

Preferably, the method of forming an inlet throttle (100) comprises coupling the two actuators (130a,b) to the housing (110) proximate the opposite ends of the flapper (120).

Preferably, the method of forming the inlet throttle (100) comprises positioning the two actuators (130a,b) to rotate the drive shafts (132a,b) about the axis of rotation (X).

Preferably, the method of forming the inlet throttle (100) further comprises adapting the two actuators (120) to receive signals that rotate the drive shafts (132a,b) in opposite directions.

Preferably, the method of forming the inlet throttle (100) further comprises adapting the two actuators (130a,b) to rotate the drive shafts (132a,b) with an equal amount of torque.

According to an aspect, an inlet throttle control system (200) comprising a throttle valve (100) including a flapper (120) that rotates about an axis of rotation (X), and two actuators (130a,b) with drive shafts (132a,b) coupled to opposing ends of the flapper (120) such that the drive shafts (132a,b) rotate coaxial with the axis of rotation (X). The inlet throttle control system (200) further comprises a controller (210) adapted to provide a signal that rotates the drive shafts (132a,b) in opposite directions.

Preferably, the inlet throttle control system (200) further comprises a cable assembly (220) that carries a signal that rotates the drive shafts (132a,b) in opposite directions.

### BRIEF DESCRIPTION OF THE DRAWINGS

The same reference number represents the same element on all drawings. It should be understood that the drawings are not necessarily to scale.

FIG. 1 shows a perspective sectional view of an inlet throttle 100 according to an embodiment.

FIG. 2 shows an inlet throttle control system 200 according to an embodiment.

### DETAILED DESCRIPTION

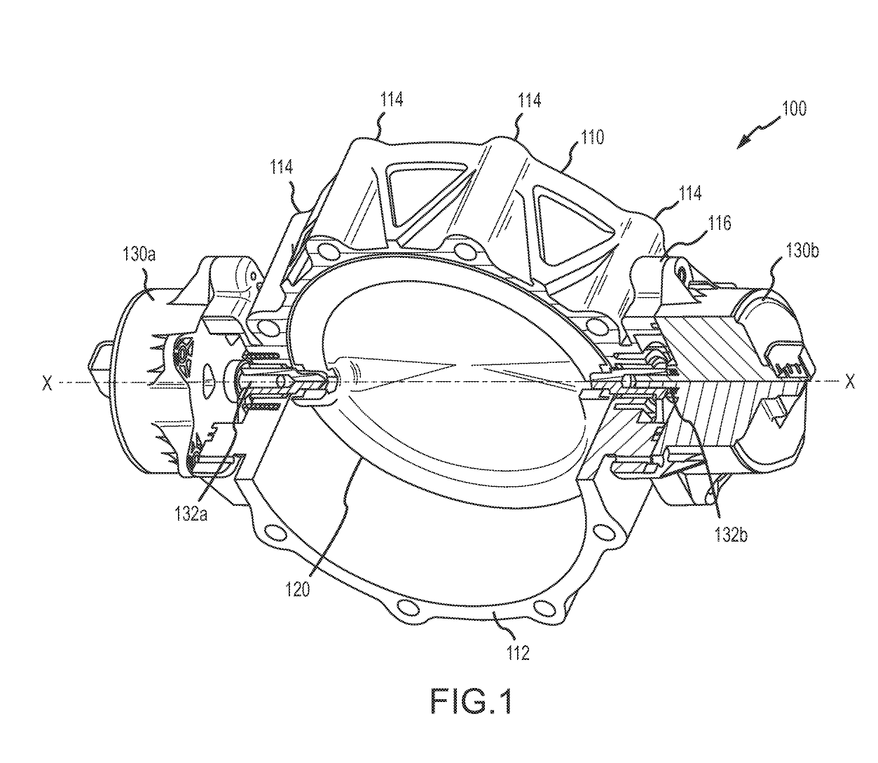

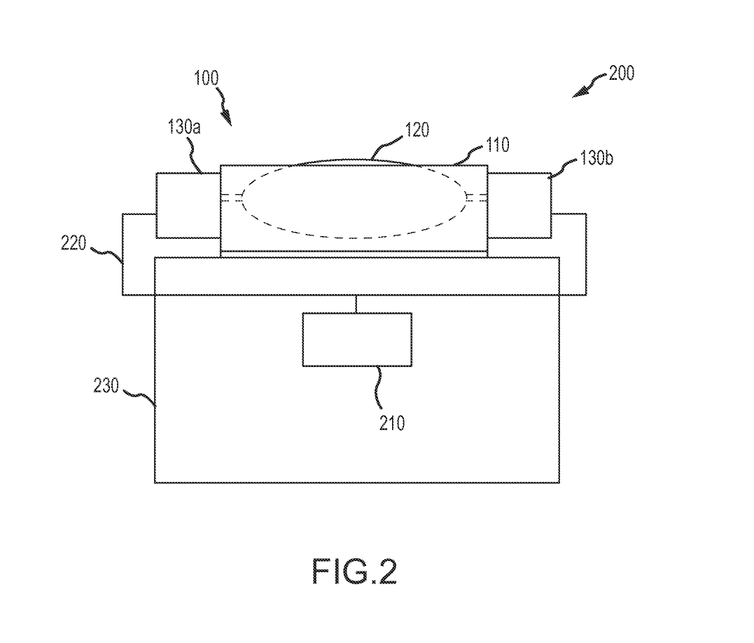

FIGS. 1 and 2 and the following description depict specific examples to teach those skilled in the art how to make and use the best mode of embodiments of an inlet throttle. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the inlet throttle. As a result, the embodiments described below are not limited to the specific examples described below, but only by the claims and their equivalents.

FIG. 1 shows a perspective sectional view of an inlet throttle 100 according to an embodiment. As shown, the inlet throttle 100 includes a housing 110 that is coupled to a flapper 120. The flapper 120 is disposed inside the aperture 112 such that the housing 110 surrounds the flapper 120. The inlet throttle 100 also includes two actuators 130a,b. The actuators 130a,b are coupled to the housing 110. The actuators 130a,b are also coupled to opposite ends of the flapper 120.

The housing 110 is includes an aperture 112 adapted to channel a flow stream through the housing 110. The aperture 112 can also be adapted to channel the flow stream around the flapper 120. The housing 110 includes throttle mounts 114 that can be used to couple the inlet throttle 100 to an engine (described with reference to FIG. 2). The housing 110 is also adapted to hold the actuators 130a,b that are coupled to the housing 110. Actuator mounts 116 in the housing 110 are used to couple the actuators 130a,b to the housing 110. The housing 110 may be comprised of aluminum although any suitable material may be employed.

The flapper 120 is adapted to rotate about the axis of rotation X. The flapper 120 rotates about the axis of rotation X to increase or decrease the flow rate of the flow stream. Although the axis of rotation X is shown as coaxial with the centerline of the flapper 120, the axis of rotation X does not necessarily need to be coaxial with the centerline. For example, in alternative embodiments, the axis of rotation X could be between the centerline and an edge of the flapper 120. In addition, although the flapper 120 is shown as circular in shape, any suitable shape may be employed.

The actuators 130a,b have drive shafts 132a,b that are coupled to opposite ends of the flapper 120. The actuators 130a,b are positioned such that the drive shafts 132a,b rotate coaxial with the axis of rotation X. The actuators 130a,b are electric although any suitable actuators can be employed. The actuators 130a,b are shown as coupled to the housing 110 proximate opposite ends of the flapper 120, although any suitable location may be employed. The actuators 130a,b are adapted to rotate the drive shafts 132a,b in opposite directions to rotate the flapper 120. For example, if the actuators 130a,b were arranged next to each other (e.g., prior to assembly) so the drive shafts 132a,b are oriented in the same direction, the first drive shaft 132a would rotate in a direction that is opposite the direction of the second drive shaft 132b.

To rotate the flapper 120 as described in the foregoing, the actuators 130a,b can be adapted to receive a signal that rotates the drive shafts 132a,b in a direction that is opposite the other. Since the drives shafts 132a,b are oriented towards each other in FIG. 1, the drive shafts 132a,b apply a torque to the flapper 120 in the same direction about the axis of rotation X. As a result, the drive shafts 132a,b rotate in the same direction about the axis of rotation X. The actuators 130a,b can be adapted to rotate the drive shafts with equal amount of torque. As will be described in the following, the rotation of the drive shafts 132a,b can be controlled.

FIG. 2 shows an inlet throttle control system 200 according to an embodiment. The inlet throttle control system 200 is shown in a simplified block diagram for clarity. As shown in FIG. 2, the inlet throttle control system 200 includes the inlet throttle 100 which is in communication with a controller 210 via a cable assembly 220. The inlet throttle 100 and the controller 210 are shown as coupled to an engine 230. The engine 230 is typically a large displacement engine as described in the foregoing. However, the inlet throttle 100 may be used in any engine with the flow stream.

The controller 210 is adapted to send a signal to the actuators 130a,b to rotate the flapper 120. The controller 210 can also receive signals, such as flapper 120 position signals from the inlet throttle 100. The controller 210 sends the signal that rotates the drive shafts 132a,b in the actuators 130a,b in opposite directions. The signal may be comprised of rotation direction and amount of rotation. For example, the controller 210 could send a signal that rotates the actuators 130a,b a certain number of steps in opposite directions. The signal can also be comprised of, for example, a signal for the first actuator 130a and a second signal for the second actuator 130b. The cable assembly 220 is adapted to carry the signal between the controller 210 and the actuators 130a,b on the housing 110. Although the cable assembly 220 is an electrically conductive cable assembly any suitable communications means may be employed.

In operation, the controller 210 sends the signal that rotates the flapper 120 thereby regulating the flow stream in the engine 230. To rotate the flapper 120a,b, the controller 210 sends a signal that rotates the first drive shaft 132a in one direction while simultaneously rotating the second drive shaft 132b in the other direction. The signal can also control the amount of torque that is applied by the actuators 130a,b to the flapper 120. In the embodiment shown, the torque applied by each actuators 130a,b is approximately equal. However, in alternative embodiments, the torque applied by each actuators 130a,b can be different. Accordingly, the flapper 120 rotates about the axis of rotation X due to torque applied by the two drive shafts 132a,b rather than one actuator.

The embodiments described above provide an inlet throttle 100. As explained above the inlet throttle 100 includes two actuators 130a,b that rotate the flapper 120 to modulate the flow stream into the engine 230. Therefore, two drive shafts 132a,b applying two torques are used to rotate the flapper 120 to oppose and overcome the forces the flow stream applies to the flapper 120. The two actuators 130a,b are also inherently redundant. For example, if the first drive shaft 132a in the first actuator 130a fails, the other second actuator 130b can continue to rotate the flapper 120. Therefore, the engine 230 can continue to operate. In addition, the size of the inlet throttle 100 can be smaller and more uniform than prior art inlet throttles which utilize one large actuator on one side. Accordingly, the inlet throttle 100 may be more easily installed in increasingly confined engine bays. The two actuators 130a,b are also able to rotate more rapidly at a given torque than one large actuator due to the actuators 130a,b having a smaller moment of inertia about the axis of rotation X. Other benefits are realized such as less expensive and smaller number of components, reduced assembly time, and reduction in cost of production.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other throttles, and not just to the embodiments described above and shown in the accompanying figures. Accordingly, the scope of the embodiments described above should be determined from the following claims.

We claim:

1. An inlet throttle (100) comprising:
a housing (110) with an aperture (112) adapted to channel a flow stream through the housing (110);
a flapper (120) disposed inside the aperture (112) and rotatably coupled to the housing (110) along an axis of rotation (X); and
two actuators (130a,b) with drive shafts (132a,b) coupled to opposite ends of the flapper (120) such that the drive shafts (132a,b) rotate coaxial with the axis of rotation (X).

2. The inlet throttle (100) of claim 1 wherein the two actuators (130a,b) are coupled to the housing (110) proximate the opposite ends of the flapper (120).

3. The inlet throttle (100) of claim 1 wherein the two actuators (130a,b) are positioned to rotate the drive shafts (132a,b) in the same direction about the axis of rotation (X).

4. The inlet throttle (100) of claim 1 wherein the two actuators (120) are adapted to receive signals that rotate the drive shafts (132a,b) in opposite directions.

5. The inlet throttle (100) of claim 1 wherein the two actuators (120) are adapted to rotate the drive shafts (132a,b) with an equal amount of torque.

6. A method of forming an inlet throttle (100) comprising:
forming and adapting a housing (110) with an aperture (112) to channel a flow stream through the housing (110);
forming and disposing a flapper (120) inside the aperture (112) and rotatably coupling the flapper (120) to the housing (110) along an axis of rotation (X); and
forming and coupling two actuators (130a,b) with drive shafts (132a,b) to opposite ends of the flapper (120) such that the drive shafts (132a,b) rotate coaxial with the axis of rotation (X).

7. The method of forming the inlet throttle (100) of claim 6 further comprising coupling the two actuators (130a,b) to the housing (110) proximate the opposite ends of the flapper (120).

8. The method of forming the inlet throttle (100) of claim 6 further comprising positioning the two actuators (130a,b) to rotate the drive shafts (132a,b) about the axis of rotation (X).

9. The method of forming the inlet throttle (100) of claim 6 further comprising adapting the two actuators (120) to receive signals that rotate the drive shafts (132a,b) in opposite directions.

10. The method of forming the inlet throttle (100) of claim 6 further comprising adapting the two actuators (130a,b) to rotate the drive shafts (132a,b) with an equal amount of torque.

11. An inlet throttle control system (200) comprising:
a throttle valve (100) including:
a flapper (120) that rotates about an axis of rotation (X); and
two actuators (130a,b) with drive shafts (132a,b) coupled to opposing ends of the flapper (120) such that the drive shafts (132a,b) rotate coaxial with the axis of rotation (X); and
a controller (210) adapted to provide a signal that rotates the drive shafts (132a,b) in opposite directions.

12. The inlet throttle control system (200) of claim 12 further comprising a cable assembly (220) that carries a signal that rotates the drive shafts (132a,b) in opposite directions.
